(19) United States
(12) Patent Application Publication
(10) Pub. No.: US 2010/0123022 A1
(43) Pub. Date: May 20, 2010

(54) Driving phase change in a fluid flowing through a nozzle

(76) Inventors: Brian P. Roarty, Los Altos, CA (US); Carol J. Walker, Ventura, CA (US)

Correspondence Address: GEORGE S. COLE, ESQ., 495 SEAPORT COURT, SUITE 101, REDWOOD CITY, CA, 94063, US

(21) Appl. No.: 12/657,351

(22) Filed: Jan. 19, 2010

Related U.S. Application Data
(63) Continuation-in-part of application No. 10/797,255, filed on Mar. 10, 2004.

(51) Int. Cl. B05B 1/24; B05B 1/00

(52) U.S. Cl. 239/135; 239/591

(57) ABSTRACT

Usable work can be obtained from the recompression of an incompressible fluid flowing into and through a nozzle's inlet and throat when that fluid has, by the exhaust end of the nozzle, been converted at least in part to a compressible gas, if the nozzle and fluid are prepared and the fluid stimulated in and by the nozzle so as to enable heat-releasing, presumably LENR, reactions that cause the phase change in the fluid.

### CROSS REFERENCE TO RELATED APPLICATIONS

This is a continuation-in-part (“CIP”) in part of application Ser. No. 10/797,255, filed on Mar. 10, 2004. This CIP application is filed to continue the prosecution, separately, of the invention described in claims 1-27 below and expressly incorporates both below and by reference all of the original application's specification and drawings.

### STATEMENT REGARDING FEDERALLY SPONSORED RESEARCH OR DEVELOPMENT

Not Applicable

### DESCRIPTION OF ATTACHED APPENDIX

Not Applicable

### FIELD OF THE INVENTION

This invention relates to a system for making use of a fluid driven through a nozzle by a phase change from liquid to gas caused through a stimulated release of energy latent within individual atoms within the fluid or interior surface of the nozzle. This release of energy causes atoms, serially and repeatedly, to be changed and for the fluid to be heated locally enough to undergo the phase change into a gas. The prior art fully teaches multiple alternative variations on how to provide, recompress, and recirculate the fluid and how to translate heat produced within the nozzle into real work.

### BACKGROUND OF THE INVENTION

Conventional nozzles are routinely divided between two nozzle classes, one for incompressible fluids and the second for compressible fluids. Each of these classes of fluids behaves somewhat differently as it flows through a nozzle, where the area of a surface perpendicular to the flow vector reduces to the narrowest (for incompressible fluids) and then increases again (for compressible fluids).

Absent substantial change in any thermodynamic flow variable, the velocity of an incompressible fluid increases as the fluid approaches the throat (i.e. within the inlet section) and achieves a local maximum velocity at or near the throat. In contrast, under selected conditions a compressible fluid may achieve a special value of velocity (e.g., sonic speed in the fluid) at or near the throat, while the fluid velocity may be greater than this special value in the exhaust section.

A liquid fluid which is incompressible may become compressible if it changes phase, either as a partial mixture of liquid and gas or as a completely phase-changed gas. A nozzle arrangement whereby the fluid flowing through the nozzle is incompressible on one side of the throat, experiences a phase change and becomes compressible, with a resultant expansion in volume, as it passes through the throat into the exhaust, may manifest distinct features and advantages in energy usage.

The amount of energy required to induce a phase change is called the heat of transformation, which, for a mass m of a pure substance, is given by the equation Q=mL, where L is the Latent Heat of the substance and depends on the nature of the phase change as well as the properties of the substance. Lᵥ is the heat of vaporization, or the energy needed to transform a liquid to a gas. For water (H₂O), Lᵥ is 2.26×10⁶ J/kg. Introductory physics texts may not include or mention as a property of the substance that it is at a normal pressure of 1 atmosphere; i.e. they may ignore the conditions of the environment. Introductory physics texts will at least mention the three main means of heat transfer as conduction, convection, and radiation, using this last word in the thermodynamic sense of inter-molecular transmission through a medium, rather than in an atomic-physics sense suggesting an intra-atomic transformation. The prior art also covers the traditional means for inducing a phase change by heating the fluid through conduction, convection, and radiation (using this word with the same limited sense) or by inducing combustion or other chemical, i.e. inter-molecular, changes in the fluid (as, for example, in a petroleum-fired diesel, tubine, or gasoline engine). All such prior art requires either a combustive change to the fluid, or a source of heat external to the fluid, even current nuclear-powered engines such as those used in nuclear-power plants.

With fluids and gases, both heat and work depend on the process by which a system moves between states; the start, intermediate, and final state, and the pressure, temperature, and volume, all interact. Since the basic formula expressing the work done by a gas is an integral which depends upon the pressure and volume, varying any or all of these affects the calculation of the final result. This formula is:

W=∫_{Vi}^{Vf}PdV Eq. 1

where W is the measure of Work done the by gas, Vᵢ is the initial volume, V_{f} is the final volume, P is the Pressure, and dV is the change in Volume between Vᵢ and V_{f}. In a cyclic process a first approximation of the work potentially made available equals the heat transferred into a system. See, e.g. Physics for Scientists and Engineers, 3d Edition, R. A. Serway, 1986, 1990, 1992, Harcourt Brace Jovanovitch, ISBN 0-03-096027-4, p. 550-551.

What is needed is a nozzle with appropriate material properties and functional structure and elements that supports incompressible flow upstream of, and compressible flow downstream of, a nozzle throat, wherein those functional structure and elements provide the conditions and stimuli causing a release of energy latent within the molecules or atoms of either the interior lining of the nozzle or of the fluid (such latent energy is not to be confused with the latent heat of the fluid) through an intra-molecular or intra-atomic, but definitely non-combustive and non-chemical transformation, and then uses the heat arising from this energy release to cause the phase change in the fluid, which is then used by the rest of the system in which the nozzle fits to produce a useful form of work.

### SUMMARY OF THE INVENTION

These needs are met by the present embodiment of the invention, which provides a system with a nozzle and containing a fluid, both now further described. The nozzle with an inlet, throat, and exhaust, is constructed to promote, sustain and contain repeated energy releases into and the subsequent phase change of the fluid from liquid to gas, and is also constructed of a mixture of materials incorporating both conductive materials (in the preferred embodiment metals such as any of nickle, palladium, platinum, copper, silver, or gold, alone or in alloy) and having intimate contact with a silicate amorphous crystalline solid or glass.

The nozzle also incorporates means to stimulate (“stimulating means”) individual atoms in the fluid F or at or within the interior surface layer of the nozzle, thereby inducing a release of energy latent within those molecules, each said release producing sufficient heat to induce a phase change locally within the fluid F. While each release may be particular to a single atom and produce a measurable, discrete ‘heat spike’; a series occurs over time and the set of atoms comprising the fluid F and nozzle, thus providing a general source of heat which can be transformed by the system into work.

Both nozzle and fluid F are free from dampening contamination from fragments or threads of tetrafluoroethelynes (such as Teflon®). In the preferred embodiment the fluid F, while chiefly composed of H₂O or D₂O, also contains a silicate either in suspension or solution. Also, the fluid F is a liquid already at or near its boiling point at the pressure at which it enters the inlet, and the stimulating means operate while the fluid F is passing through the throat.

The stimulating means applied to the fluid F may be electronic, magnetic or photonic stimulation of a portion of the throat, or of a portion of the fluid F at the throat, or some combination of electronic, magnetic and photonic stimulation of throat and fluid F. In the preferred embodiment, the stimulating means will support a resonance stimulus. The phase change may be further supported by including a surfactant in the fluid F that promotes and enhances the low energy nuclear reactions (LENR). In further embodiments, to enhance the conversion and phase change of the fluid F, the system may vary the stimulation to affect the timing and power of the conversion and phase change of the fluid F.

### BRIEF DESCRIPTION OF THE DRAWINGS

In all of the drawings, control and support wiring are not shown since they are known in the prior art.

FIG. 1 is a planar cross-section of a nozzle with the structural substrate, stimulating means, metallic block, and amorphous silica lining in the throat.

FIG. 2 is a planar cross-section of an alternative nozzle with layering of stimulating means, metallic block, and amorphous silica lining in the throat.

FIG. 3 is a cut-away, three-dimensional cross-section of a nozzle embodying the material layering of FIG. 2.

FIG. 4 is a planar cross-section of a nozzle showing the stimulating means in the throat close to its input end and immediately preceding the metallic block, while the amorphous silica lining forms the widening exhaust.

FIG. 5 is a planar cross-section of a nozzle showing the means for providing the stimulating input in the throat at its exhaust end, interacting with the metallic block which, followed by the amorphous silica lining, forms the widening exhaust.

FIG. 6 is a cut-away, three-dimensional cross-section of a nozzle embodying several combined means for providing the stimulating input, each embedded near the input end of a separate metallic block which extends in the direction of flow, with the silicate lining otherwise forming the entirety of the throat and exhaust.

FIG. 7 is a planar cross-section view of a nozzle with the stimulating means embedded at the input end of each metallic block, which in this variation is covered by the amorphous silicate lining, so the stimulation passes through both the metallic block and the amorphous silicate lining before reaching the fluid F.

FIG. 8 is a planar cross section of an alternative construction, differing from FIG. 7 in that it omits the metallic block and has the stimulating means preceding the amorphous silicate lining.

FIG. 9 is an example of a phased electrical stimulation where the intensity of the electrical stimulus periodically jumps between a low and high state.

FIG. 10 is an example of a repeated scaling increase in electrical stimulation where the intensity of the electrical stimulus periodically changes from a low to a higher state, then back to the low state, then back to a yet higher state, increasing with each upward jump a number of times (in this example, 4), pauses, and then the cycle repeats.

FIG. 11 is a flat nozzle where the change in volume occurs in the X-Y planes (length-width), as might be most suitable for a microengineering or nanoengineering, molecular-level construction, showing the means for providing the stimulating input to the fluid in the throat close to its input end, immediately preceding the metallic block, while the amorphous silica lining both precedes the embedded stimulating means and forms the exhaust-side end of the throat and the widening exhaust; this also incorporates sensing and feedback elements in the throat and exhaust.

FIG. 12 is an alternative embodiment similar to FIG. 11, omitting the metallic block and with the stimulating means in and through the amorphous silicate lining.

FIG. 13 shows a pattern of electrical stimulation by an AC current as may be obtained by adding a sinusoid with a frequency of 3.1 MHz to another sinusoid having a frequency of 43.4 MHz, forming the beat frequency of the swo sinusoids, which is a stimulation pattern detected from the system, nozzle and fluid during the LENR reaction and applied as an input feedback through the stimulating means to promote resonance of the underlying reaction.

### DETAILED DESCRIPTION OF THE DRAWINGS

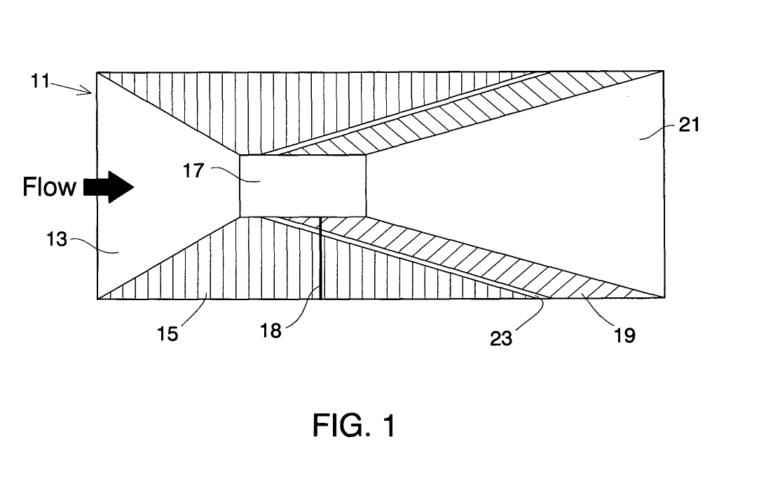

FIG. 1 is a planar cross-section view of a nozzle 11 through which flows a fluid F (not shown), with the x-axis being both the direction of flow of the fluid F and passing from the left to right side of the view. The nozzle 11 includes an inlet 13, a throat 17, and an exhaust 21. The nozzle may be composed of multiple layers of materials from inlet to exhaust including a structural core 15, an amorphous silicate lining 19, and a metallic block 23 which at some portion becomes the interior surface lining of the throat 17 and elsewhere is overlain by the amorphous silicate lining 19. Both the throat 17 and exhaust 21 may encourage and support the phase change of the fluid F. Also present is a set of stimulating means 18 (hereinafter ‘stimulating means’) which may affect one or more of the metallic reactive layer 23, the amorphous silicate lining 19 or the fluid F.

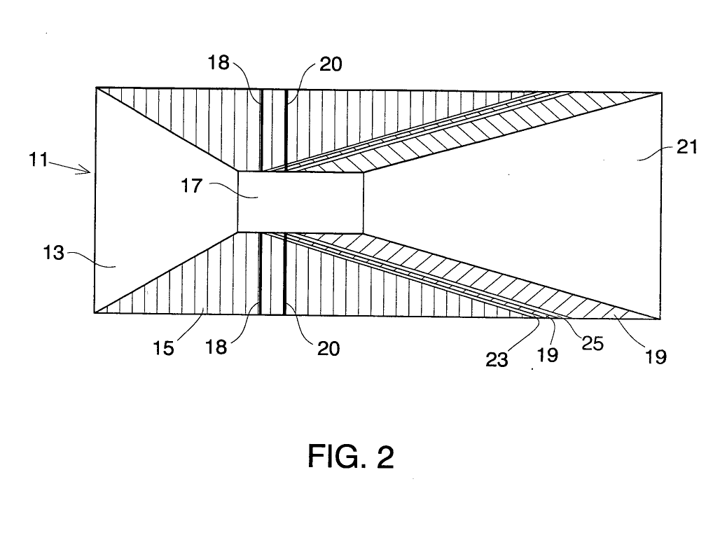

FIG. 2 is another planar cross-section view of a nozzle 11 that, like FIG. 1, parallels the x-axis of the fluid flow F. FIG. 2 shows the structural core 15 which first defines the inlet 13 and the initial portion of the throat 17, where it meets a first metallic block 23. The throat 17 then alternates layers of the amorphous silicate lining 19 and the next layer of metallic block 25. FIG. 2 additionally shows separate stimulating means 18, 20 for each layer of metallic block 23, 25.

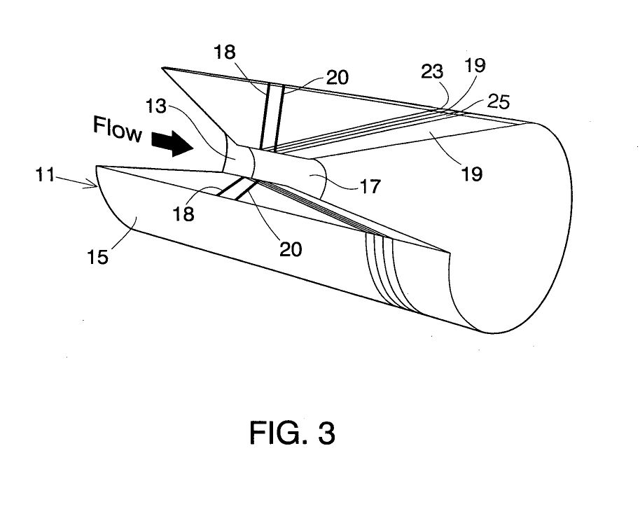

FIG. 3 is a three-dimensional view of a nozzle layered as described in FIG. 2.

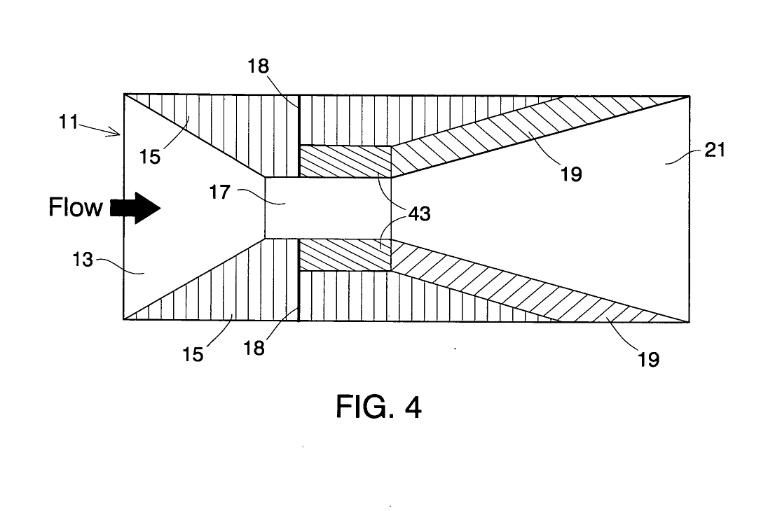

FIG. 4 is, like FIG. 1, another planar cross-section view of a nozzle 11 with the x-axis being both the direction of flow of the fluid F and passing from the left to right side of the view. The nozzle 11 in this embodiment includes in the throat 17 embedded stimulating means 18 at the front of a metallic block 43 which is followed by the amorphous silicate layer 19 in the exhaust.

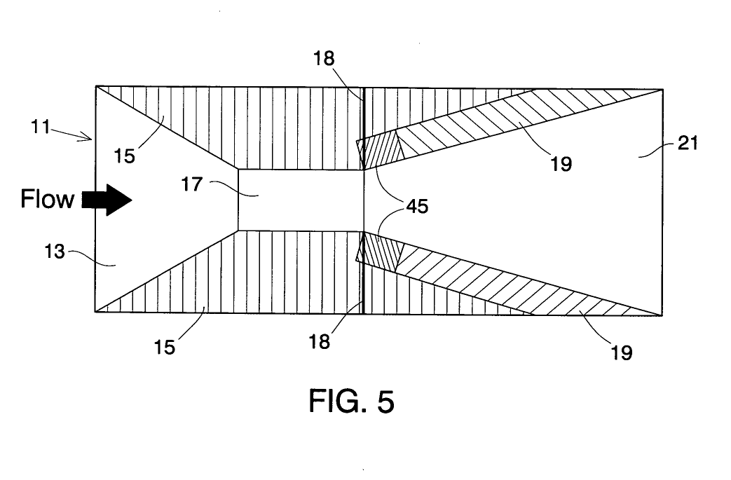

FIG. 5 is, like FIG. 1, another planar cross-section view of a nozzle 11 with the x-axis being both the direction of flow of the fluid F and passing from the left to right side of the view. In this embodiment the embedded stimulating means 18 enters the metallic block 45 at the start of the exhaust 21, and the amorphous silicate lining 19 follows the metallic block 45.

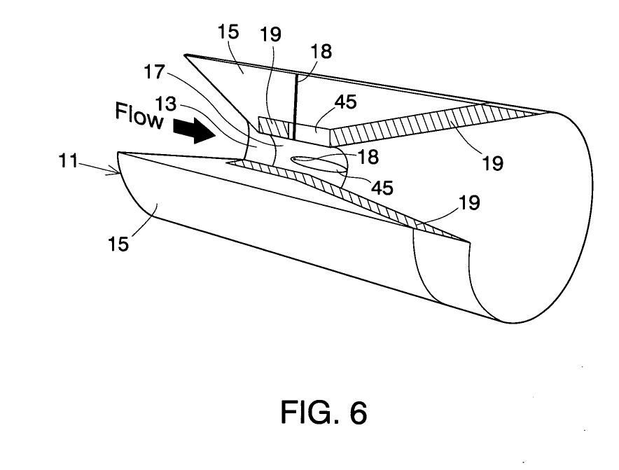

FIG. 6 is a cut-away, three-dimensional cross-section of a nozzle 11 embodying multiple, coordinated and combined stimulating means 18 and metallic blocks 45, wherein each metallic block 45 extends lengthwise parallel to the direction of flow and has a stimulating means 18 embedded at the edge nearest the inlet 13, and wherein each combined stimulating means 18 and metallic block 45 is preceded, followed, and surrounded by the amorphous silicate layer 19 which otherwise forms the entirety of the lining of both throat 17 and exhaust, separating both from the structural core 15. The upper interior cut-away of the throat 17 shows a combined embedded stimulating means 18 and metallic block 45, preceded and followed by the amorphous silicate layer 19; the middle of the throat 17 shows another combined embedded stimulating means 18 and metallic block 45 flat-on; and the lower interior cut-away of the throat 17 shows that where there is no combined embedded stimulating means 18 and metallic block 45 the amorphous silicate layer 19 forms the entirety of the surface lining of the throat 17 and exhaust.

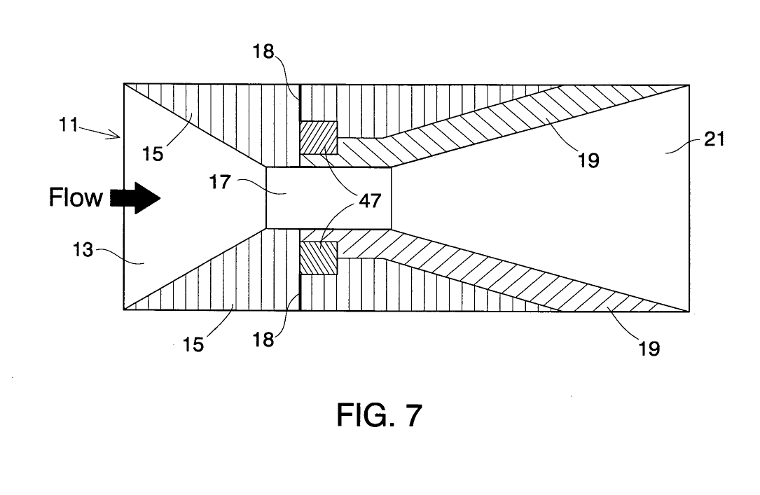

FIG. 7 is, like FIG. 1, a planar cross-section view of a nozzle 11 with the x-axis being both the direction of flow of the fluid F and passing from the left to right side of the view. The nozzle 11 in this embodiment includes in the throat 17 stimulating means 18 embedded at the input end of each metallic block 47, which in an alternative embodiment may be a single torus, with both covered by the amorphous silicate lining 19 that forms the majority of the interior lining of the throat 17 and exhaust 21.

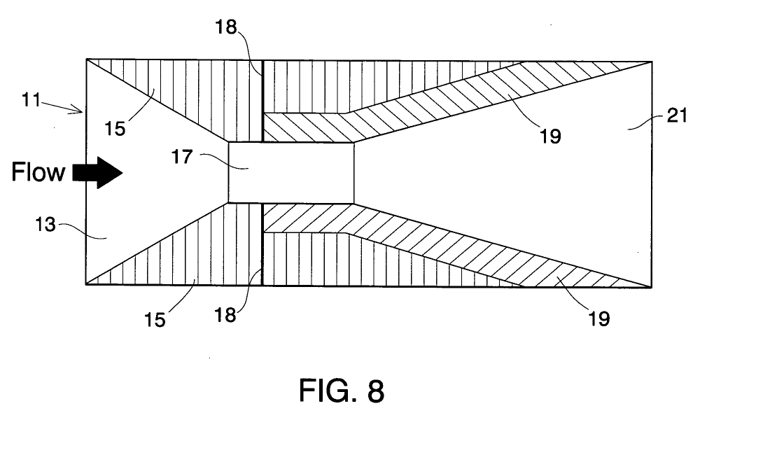

FIG. 8 is a planar cross section of an alternative construction, differing from FIG. 7 in that it omits the metallic block and has the embedded stimulating means embedded at the edge of the amorphous silicate lining 19 nearest the inlet 13.

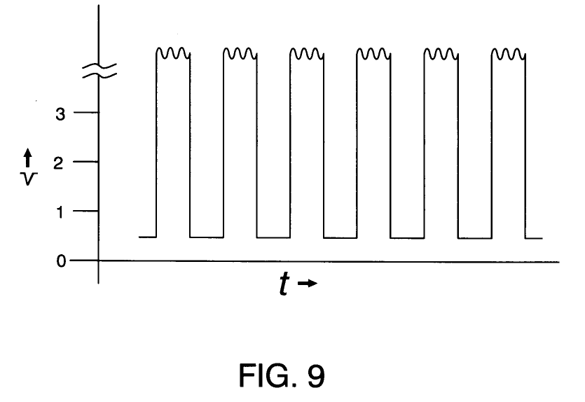

FIG. 9 shows a pattern of electrical stimulation, where the voltage pulses between low and high values (the v axis) in a timed pattern of identical sinusoidal pulses (the t axis). The values are not absolute but exemplar to show the nature of the pattern of pulses.

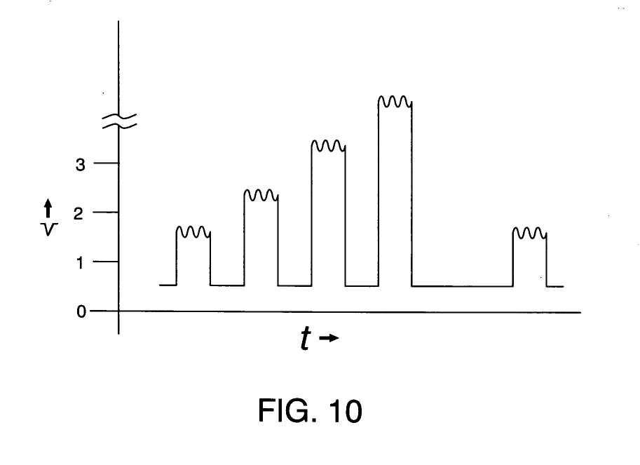

FIG. 10 shows a pattern of electrical stimulation where the voltage pulses between low and higher values (the v axis) in a laddered increase over time (the t axis), which pattern repeats periodically after a rest. The values are not absolute but exemplar to show the nature of the pattern.

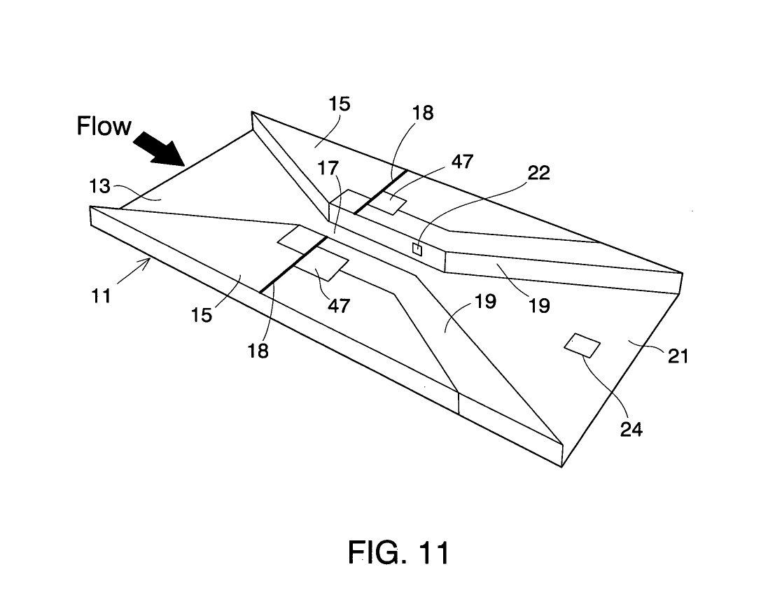

FIG. 11 shows a flat nozzle where the majority of the changes in the volume of the fluid F (not shown) flowing through the nozzle occur both between the inlet 13, throat 17, and exhaust 21, and in occurs in the X-Y planes (length-width). The means for providing the stimulating input 18 to the fluid F are close to the end of the throat 17 nearest the inlet 13 and at the same end of each metallic block 47, while the amorphous silica lining 19 both precedes the embedded stimulating means 18 and otherwise is the lining of both throat 17 and exhaust 21. Also in the throat 17 and exhaust 21 are sensing and feedback elements 22, 24. This form of nozzle may be preferable for microengineered or nanoengineered nozzles where the layers of materials forming the structural core 15, metallic material 47 and amorphous silicate lining 19 are better engineered by layering and etching than through 3-D curvature construction methods.

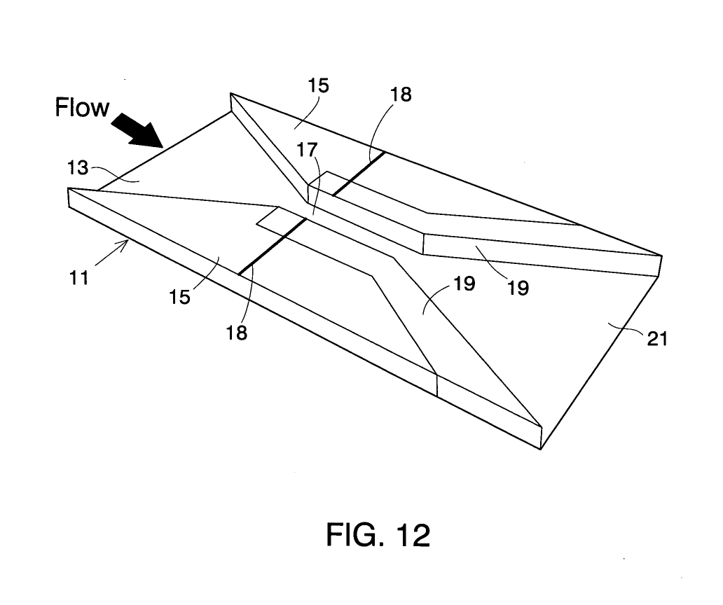

FIG. 12 is an alternative embodiment similar to FIG. 11, but in this drawing the embedded stimulating means 18 are in the throat 17 and are both nearer the inlet 13 than the exhaust 21 and are in and through the amorphous silicate material 19, without any metallic block.

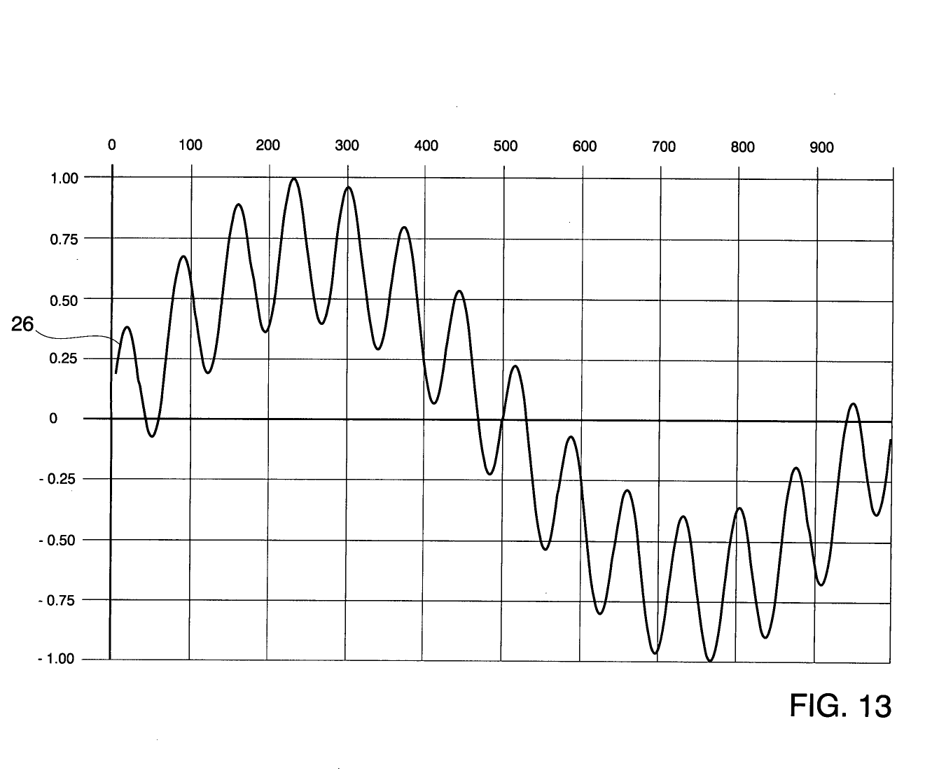

FIG. 13 shows a pattern of electrical stimulation by an AC current as may be obtained by adding a sinusoid with a frequency of 3.1 MHz to another sinusoid having a frequency of 43.4 MHz, forming the ‘doubly layered sinusoid’ disclosed by this drawing, wherein the x-axis is time and the y-axis is frequency, a stimulation pattern detected from the system, nozzle and fluid and resonantly echoed back through the stimulating means.

### DETAILED DESCRIPTION OF THE INVENTION

The system comprising the present embodiment of the invention includes a nozzle, a fluid F flowing through the system and nozzle, and means for inducing a phase change in the fluid F within the nozzle through a stimulated release of energy within atoms of the interior surface of the nozzle or of the fluid immediately within, at, or near that interior surface of the nozzle (a set of stimulating means). This set of stimulating means will stimulate a repeated release of energy latent within atoms inside the nozzle, whether of the fluid or interior surface of the nozzle, and thereby cause the fluid to be heated so as to change phase into a gas. Whether said energy release is separately considered to be a transient burst of heat or “heat spike” or forms a measureable, general and sustained increase, it will transfer sufficient heat into the fluid F to induce part of the fluid F to experience a phase change from liquid to gas within the nozzle. In the preferred embodiment of the invention the system further comprises means for transforming the flow of fluid F from the nozzle's exhaust into work that can be transferred outside the system and thus extracting useful work from the phase-changed gas, and also for reconstituting the fluid into a liquid. This enables the stimulating means to repeatedly drive a phase change in the fluid F and the repeated phase changes then drive the fluid F through the nozzle and system.

The nozzle will incorporate a complex construction rather than being made of a single material, for it will comprise a structure having a narrowing inlet, a minimal-width throat, and a widening exhaust with a structural base forming the bulk of the exterior and mass of the structure; and an interior lining different from the structural base, through or into which the set of stimulating means extend. In an alternative embodiment it may incorporate an an insulating layer between the structural base and the interior lining; and in yet another alternative embodiment it will incorporate a feedback element connected from the interior lining to the set of stimulating means, or multiple feedback elements separably or interactively connected to some, each, or each and every, unit of the set of stimulating means; in an alternative embodiment such a feedback element will be a thermocouple.

External condensation and recirculating elements, filtering, control and timing means, and mechanical energy transmission means are well known in the prior art and are neither shown nor claimed as part of this invention; however, its application and use in combination with these are not so disclaimed and may be additional parts to each of the embodiments herein.

The system and nozzle, and the set of stimulating means, will repeatedly induce a low-energy nuclear reaction (LENR) in the atoms of any of the fluid and nozzle, thereby producing the repeated release of energy latent within atoms inside the nozzle, whether of the fluid or interior surface of the nozzle, and thereby cause the fluid to be heated so as to change phase into a gas. To enable the practice of this invention this disclosure includes details which, while not claimed separately, differentiated between repeatable and measurable energy releases and non-effective or indeterminate efforts to obtain the same.

Preparation, Preferences, and Precautions (“Do's and Don'ts”)

The entire system is prepared by the contained fluid F being brought to and kept at a stable equilibrium temperature at or slightly above its boiling point, with the fluid F isolated from the external atmosphere, and the nozzle and system thermally insulated from loss and wastage of heat energy. Preparation may continue for two or more (several) hours. The fluid F in the preferred embodiment is water incorporating electrolyte and surfactant elements in solution such that the fluid F has a pH between 6.5 and 8.9 and incorporates a silicate having the general formula of LiᵢSiₘOₙ. In an alternative embodiment the fluid F incorporates an anionic silica hydride comprising a silsesquioxane composition.

It should be noted that this invention does not find it necessary to use deuterium (that is ‘heavy’ as opposed to ‘ordinary’ water) in order to obtain the heat spikes, transmutation, and other behavior of a non-chemical reaction, although heavy water is preferred. Such phenomena even arose through a run that was made with ‘ordinary’ water as the fluid F, although the latter was not subjected to expensive isotopic analysis to determine the actual (as opposed to ‘standard’ or ‘presumed’) randomized distribution found in ordinary, metropolitan-supplied, tap water.

However, the fluid F must be free from contamination by extraneous metallic particles and most particularly from particles or threads of the polymer polytetrafluoroethylene (PTFE) more commonly known as Teflon®. Although silicates and PTFE are known to be good electrical and thermal insulators, and silicates prove to be vital to the proper functioning of the system, contamination by scrapings or particles of polytetrafluoro-ethylene appears to vitiate, dampen, or even negate any stimulated energy release and LENR. Since many experiments were run where the stimulating and measuring elements reached the fluid F via Teflon® seals and that material was believed to be of no or little effect (and thus at first no effort was made to prevent such accidental contamination from ‘fitting-in scrapings’), this was definitely an unexpected and unpredicted result. Also, rubber gaskets should be avoided as rubber seems to be a contaminant.

Furthermore, the entire system should be sealed to avoid ‘boiling off’ of the fluid F, as eventually such loss will cause the system to cease to function. Equally, the system should be so constructed as not to be damaged by the additional pressure generated by either any phase change (steam explosion), individual or repeated, either in the nozzle or the remainder of the system. Since the experiments did not observe significant reduction in the fluid from ‘boil off’ while the preparation was maintaining the temperature at or near the boiling point of the fluid F, but did observe such significant reduction in the fluid from ‘boil off’ after the preparation period when the stimulating means were activated, this was an unexpected and unpredicted result (indeed, one contradicted by theory and assertions of non-present, non-participating individuals).

Additional details, particularly appertaining to the materials used and patterns of stimulation produced by the stimulating means incorporated in the nozzle, as to how they should be treated and activated, may be found in another patent application by the same inventors describing a protocol for treating material surfaces submitted by the same applicants on or about the date of this submission (application Ser. No. 12/688,630, filed Jan. 15, 2010) which confirms the existence of Low Energy Nuclear Reactions and which protocol has been shown to repeatedly generate those reactions.

### Description of Nozzle Elements and Stimulating Inputs

The nozzle will have a structure having a narrowing inlet, a minimal-width throat, and a widening exhaust, a structural base forming the bulk of the exterior and mass of the structure; a set of stimulating means that stimulate a repeated release of energy latent within atoms inside the nozzle, whether of the fluid or interior surface of the nozzle, and thereby cause the fluid to be heated so as to change phase into a gas; and an interior lining. It may also incorporate either or both of an insulating layer between the structural base and the interior lining and at least one feedback element.

### The Interior Lining

The interior surface of the nozzle which contacts the fluid, generally the interior lining, should not be of a non-conductive metal or of a conductive metal when the latter is not part of a stimulating, controlling, or sensing means, i.e. when the material is merely structural and not intended to effect the phase change of the fluid F. There may be a mix of a metallic block 23, 25, 43, 45, 47 that is part of the stimulating means, i.e. is in contact with an electrode and functions as a part thereof, and of an amorphous silicate 19. The interior lining not part of the stimulating, controlling or sensing means (in the drawings chiefly the amorphous silicate 19) may overlay or lap around the metallic block 23, 25, 43, 45, 47 and will overlay the whole or part the structural core comprising the inlet 13, throat 17 and exhaust 21.

### The Metallic Block

The metallic block 23, 25, 43, 45, 47 may be porous, sintered, have micro-cracks therein, or foraminous with the channels both parallel to the x-axis and with open connection to the fluid F flowing through interior of the throat 17 and amorphous silicate lining 19, to encourage to encourage or replenish or transfer energy from LENR incidences and/or other stimuli; or to encourage the conductive and convective transference of energy between the metallic block 23, 25, 43, 45, 47 and the fluid F.

Material for the metallic block 23, 25, 43, 45, 47 incorporates a material that enables, supports, or encourages a Low Energy Nuclear Reaction (LENR) and thereby provides thermal energy (heat) that is transferred to the fluid F at the interior surface of the throat 17. In the preferred embodiment of this invention, the metal forming the metallic block 19 is palladium. It may be also any of nickle, palladium, platinum, copper, silver, or gold, alone or in alloy. This metallic block may be only a plating on the inner surface of the nozzle a few molecules thick. It may also be a helical coil of palladium wire treated with the protocol described in our other patent application Ser. No. 12/688,630 filed on Jan. 15, 2010, describing a protocol for treating material surfaces submitted by the same applicants on or about the date of this submission.

### Details of the Construction

The nozzle 11 comprises an inlet 13, a throat 17, and an exhaust 21, and is where the ‘z’ axis, the interior dimension perpendicular to the fluid flow area, decreases to a minimum at the input end of the throat, remains constant through the length of x-axis of the throat, and then increases again after the exhaust end of the throat.

The nozzle 11 viewed from outside to inside begins with a structural core 15 (for strength and shape). It will incorporate a set of stimulating means 18, 20, which are means embedded within the nozzle for stimulating individual atoms of the interior or interior surface of the nozzle, or of the fluid F in, at, or flowing past the point of stimulation, and for inducing a LENR which results in a release of heat that creates a local phase change in the fluid F. The nozzle may be cylindrical (as shown in FIGS. 3 and 6) or flat (as shown in FIGS. 11 and 12). It may also incorporate an insulating layer (not shown in the drawings accompanying this application, though shown and discussed in the parent application Ser. No. 10/797,255, filed on Mar. 10, 2004). Material for the structural core 15 may be any suitable solid material, such as a metal, a sintered metal, an alloy, a ceramic, or a carbon composite that resists wear or erosion from the fluid F passing through the nozzle 11.

Within the inlet 13, the fluid F is preferably incompressible and maintained at or near conditions for a change of phase (e.g., from liquid to gas); so it could be near or at its boiling temperature yet above its boil pressure (and thus in a superheated state). The fluid F in the preferred embodiment is moved into and through the system and nozzle 11 by a pump (not shown); and the fluid may be recondensed and/or replaced by means already well-known in the art, also not shown.

As the fluid F passes through the throat 17 and into the exhaust 21, the stimulating means induce the LENR which raise the energy level of the fluid F by ΔE per unit volume that should be at least equal to, and preferably greater than, the phase change energy increment Lᵥ per unit volume required to cause a phase change in the fluid F. As a result of the phase change, the fluid F becomes compressible within at least a portion of those regions so that the fluid flow behavior is changed substantially therein.

### The Set of Stimulating Means

The set of stimulating means 18, 20, as stated above, may comprise any combination of electrical and photonic stimulating means. An electrical stimulating means will comprise at least one metallic electrode, which may be comprised of any of the set of conductive metals and their alloys. This will include a metal comprised of any of the set of metals of nickle, palladium, platinum, copper, silver, or gold, alone or in alloy. This electrode also may be lined with a silicate amorphous solid, or comprised of sintered metal and silica. There may be more than one electrode, and if there are, the different electrodes may be comprised of the same or differing metals in any combination, or with one metallic and one a conductive material other than metal. In alternative embodiments with at least two electrodes at least one is coated with silicate or silica. Such electrical stimulating means comprise at least one electrode and provide electrical stimulation to any of the metallic block, interior lining and fluid by passing a current through the electrode or, in an alternative embodiment, at least one each of anode and cathode. These may be capable of variable output, and may include any combination of direct and alternating current, with the alternating current having frequencies in the RF range, or in the absorptive spectra of the fluid F or metallic block 23, 25, 43, 45 or amorphous silica lining 19.

Photonic stimulating means may comprise at least one laser incorporated in the nozzle but directing its emission to any of the interior lining of the nozzle and the fluid, and the laser may be capable of variable emission (any of differing frequencies, intensities, or durations). Or the photonic stimulation may be a non-laser light source, which can be modulated, whether square-wave or pulse or any combination thereof, or with a frequency that varies or hops. Photonic stimulation may alternatively incorporate a set of intensity-modulated light emitting diodes (LED) directing light pulses into the fluid F, or any combination of LED and laser stimulation. The photonic stimulation could also be conveyed to the throat of the nozzle by optical fiber cable, i.e. fiber optics

In the preferred embodiment the set of stimulating means include both means for photonic stimulation comprising at least two or more “ultrabright” white LEDs capable of generating 15,000 mcd (millicandela) spaced equally around the nozzle's throat, each LED in a sealed glass port in the interior lining and directing its light into the fluid F, and means for electronic stimulation comprising at least a first anode for an RF stimulus, a second anode for a DC stimulus, and a common cathode, with the electrodes forming a triangle with two equilateral sides wherein the shortest side lies between the RD anode and the common cathode; and the electrodes are isolated from the nozzle's structure and concentrate the RF stimulus in the fluid F.

In an alternative embodiment of the invention the set of stimulating means further comprise at least one metallic electrode over which, as the silicate in the fluid F, at least one silicate bead is threaded that contacts the fluid F.

An alternative photonic stimuli source could be at least one laser, incorporated in the nozzle but directing its emission to any of the interior lining of the nozzle and the fluid. This laser could be capable of variable frequency emissions and of pulsed and patterned emissions that could resonate with any known or detected resonance of the fluid and interior lining.

In another alternative embodiment the set of stimulating means 18, 20 incorporated in the nozzle 11 would include both electrical and photonic stimulating means, the electrical stimulating means comprising an anode and a cathode and the photonic stimulating means comprising a laser directing its emission to any of the interior lining of the nozzle and the fluid.

### Stimulating Inputs

When stimulating input is provided, either an electrical or photonic stimulus or both, in the preferred embodiment it is provided so as to emphasize the natural resonance of the fluid F and materials of the nozzle's interior lining, as known beforehand or detected during the operation of the system.

Given the apparent resonance, we believe that our modulated electrical and photonic stimuli are affecting the silica bonds. The electrical stimulus is especially suspect in that regard. When viewed with an Agilent 4195A spectrum analyzer, one of the effective stimuli was shown to be a rich comb of spectra in the range of 1 MHz to 200 MHz, spaced at 6.2 MHz and having peaks in the profile of the spectral comb at 3.1 MHz and 50 MHz, which were the frequencies of the underlying pulses and the sinusoidal modulation of those pulses. That stimulus provided literally dozens of spectra that could have been at resonant frequencies.

The RF stimulus in the preferred embodiment is applied at one or more frequencies absorbed by the solution and at one or more natural frequencies emitted and detected during the LENR reaction. Depending on the cost and complexity limitations imposed on any system in which the nozzle is placed, feedback elements—which may incorporate sensing and signalling sub-elements, whether within the nozzle or system or physically external to the fluid flow elements but still detecting emanations from the system or nozzle and communicating with either or both—are included. These feedback elements will detect transient emitted signals from within the nozzle, identify them, and repeated them back through the stimulating means. One example of a sensing and feedback element is a thermocouple well projecting into the fluid, as has been used to monitor the temperature of the fluid. The thermocouple well or wells passed through the surrounding material via Teflon® seals compressed with Swagelok® fittings and while first made with steel were later made with glass. One observed set of signals emitted during the observed heat increases, presumably by the LENR phenomena, closely resembled a 3.1 MHz sinusoid added to a 43.4 MHz sinusoid (thus a doubly layered sinusoid), distorted by noise, as shown in FIG. 13. Improved results were obtained when an amplifed and less noisy signal with those frequencies was used as a stimulus. Similar reasoning could be applied to the photonic stimulus.

### Stimulating Input Patterns

The set of stimulating means may produce a continual (steady-state) stimuli, or periodic or patterned stimuli. If both electrical and photonic stimulation are provided, these may occur concurrently, sequentially, or variably. The stimuli provided by the set of stimulating means may be constant, or may vary periodically, including a periodic pattern of increasing impulses.

The electric stimulation may comprise any combination of an RF comb of spectra with spaced peaks in a range of 1 MHz to 200 MHz, a replication of the electrical energy emitted during the desired exothermic reaction (including an amplified replication), a sinusoidal signal have a frequency between 1 MHz and 20 MHz added to another sinusoidal signal having a frequency between 25 MHz and 100 MHz, and a pattern obtained by adding a sinusoid with a frequency of 3.1 MHz to another sinusoid having a frequency of 43.4 MHz, forming the ‘doubly layered sinusoid’.

### The Fluid

The fluid F may initially be a liquid, such as water, with a nominal or substantial amount of deuterium (D) present, as HDO or D₂O, or the fluid F may be another liquid that has a substantial portion of its H atoms replaced by D atoms (each containing one proton and one neutron). Alternatively, the fluid F may be an electrolytic liquid having one or more conductive salts therein, such as lithium sulfate or another suitable salt of lithium, boron, aluminum, gallium, indium or thallium.

As the viscosity of the fluid F may effect the system and thereby affect the efficiency of the heat transference, the efficiency of the LENR, or the efficiency of the phase change, in a further embodiment of the invention a wetting agent or surfactant is included in the fluid F to promote better interaction between the fluid F and the interior surface(s) of the nozzle, particularly the throat 17, the exhaust 21, the amorphous silicate lining 19, and any of the set of stimulating means 18, 20 and the metallic block 23, 25, 43, 45 that are extended to the interior surface. The preferred surfactant belongs to a class that consists of relatively small molecules from five to fifty atoms, not have a surfactant tail, and containing an extra ion. The preferred surfactant will not react with the fluid F, e.g. the silicate or the lithium or other salt.

In the preferred embodiment of the invention, the fluid F will contain a compound containing silica either in solution or in suspension. This could be a silicate, with one example of such a compound being anionic silica hydride. Others would be lithium silicate having the general formula of LiᵢSiₘOₙ or sodium silicate, or the anionic silica hydride comprised of a silsesquioxane composition. Also, in the preferred embodiment of the invention, the fluid F in the fluid is buffered to maintain a pH in the range of 6.5 to 8.9. When one or more silica compounds are used in the system, they should be treated in accordance with another patent application, Ser. No. 12/688,630 filed on Jan. 15, 2010, describing a protocol for treating material surfaces submitted by the same applicants on or about the date of this submission which confirms the existence of Low Energy Nuclear Reactions and has been shown to generate those reactions.

### Additional Details for the Preferred Embodiment

In multiple experiments providing repeated heat increases not explicable by environmental changes or chemical heating, and thus in the preferred embodiment of this invention, four “ultrabright” white LEDs capable of generating 15,000 mcd (millicandela) are spaced equally around a vessel below the surface of the liquid contained therein as photonic stimuli. These stimuli are provided through sealed glass ports in the interior surface. Electrical stimuli are provided through additional stimulating means comprising three palladium wires of 0.025″ diameter: one being an anode for the RF stimulus, a second an anode for the DC stimulus, and a third a common cathode. These electrodes form an equilateral triangle (in the experiment with sides 0.9, 1.45, and 1.45 inches long) in the plane perpendicular to the flow of the fluid F through the nozzle. The shortest side lies between the RF anode and the common cathode. Both electrodes and thermocouples are equally spaced on a bolt circle (so in the experiment the thermocouples were 0.9 and 1.45 inches away from the cathode). These experiments are further described in the aforementioned patent application Ser. No. 12/688,630.

In the preferred embodiment of the invention's nozzle and system at least two such “ultrabright” white LEDs would also be spaced equally around the nozzle's throat perpendicular to the direction of flow of the fluid F, each individually sealed in a sealed glass port in the interior lining of the nozzle 11 and directing its light into the fluid F; and the electrodes will form a triangle with two equilateral sides wherein the shortest side lies between the RD anode and the common cathode; and the electrodes are isolated from the nozzle's structure and concentrate the RF stimulus in the fluid.

In one embodiment, when an electric current is used to stimulate the LENR, the electric current may have a time-varying waveform consisting of pulses. The pulses carry a modulation that is sinusoidal or nearly so. In that embodiment, the pulse may have a repetition rate of 3 MHz and the sinusoidal frequency of 50 MHz. In a further embodiment, the pulses may increment up in amplitude in a staircase manner, until ceasing, providing a stimulus of increasing stimulation followed by relaxation. Also, if the electrical stimulation is a DC current such that the heating element is a cathode and the other electrode is an anode, provided that the anode is composed of the same metal as the cathode, the current flow may briefly reverse direction, although care must be taken that it not corrode the cathode by doing so. The resulting waveform resembles the acoustic waveform created by percussion instruments and may effect both vibration and electrical stimulation of the LENR.

If the system uses electrical stimulation, the fluid F must be either weakly or strongly conductive, and the anode should not be part of the nozzle since the anode will dissolve over time as a natural result of electrolysis.

In another embodiment of the system, the electrical stimulation may be an AC current. The preferred embodiment in that case would be a signal would be obtained by adding a sinusoid have a frequency of 3.1 MHz to another sinusoid having a frequency of 43.4 MHz. In the case where that electrical stimulus is balanced, there would be no net current flow between the electrodes.

There are a number of means for transforming a heat-exchange that produces directed steam into useful work well known in the prior art. Such means, along with condensation, recirculation, filtering, control and timing elements are not shown as these are known to the prior art.

The scope of this invention includes any combination of the elements from the different embodiments disclosed in this specification, and is not limited to the specifics of the preferred embodiment or any of the alternative embodiments mentioned above. The claims stated herein should be read as including those elements which are not necessary to the invention yet are in the prior art and are necessary to the overall function of that particular claim, and should be read as including, to the maximum extent permissible by law, known functional equivalents to the elements disclosed in the specification, even though those functional equivalents are not exhaustively detailed herein.

Additionally, the use of multiple stimulating means, metallic reactive blocks and amorphous silicate layers should be read into the claims as the language uses that singular indefinite article (‘a’, or ‘an’), and that usage is, according to practice and prior legal interpretation, not limited to the ordinal, single-unit definition but is synonymous with the permissive phrase ‘at least one’.

We claim:

1. A system for driving phase change in a fluid flowing through a nozzle, said system comprising:
a nozzle;
a fluid flowing through the system and nozzle;
a set of stimulating means that stimulate a release of energy latent within atoms inside the nozzle, whether of the fluid or interior surface of the nozzle, and thereby cause the fluid to be heated so as to change phase into a gas; and
means for extracting useful work from the phase-changed gas and reconstitute the fluid into a liquid.

2. A system and nozzle as set forth in claim 1, wherein the nozzle further comprises:
a structure having a narrowing inlet, a minimal-width throat, and a widening exhaust;
a structural base forming the bulk of the exterior and mass of the structure; and, an interior lining.

3. A system and nozzle as set forth in claim 2, wherein the nozzle further comprises an insulating layer between the structural base and the interior lining.

4. A system and nozzle as set forth in claim 2, wherein the nozzle further comprises a feedback element connected from the interior lining to the set of stimulating means.

5. A system and nozzle as set forth in claim 2, wherein the set of stimulating means will repeatedly induce a low-energy nuclear reaction (LENR) in the atoms of any of the fluid and nozzle.

6. A system and nozzle as in claim 5, wherein the set of stimulating means further comprise any combination of electrical and photonic stimulating means.

7. A system and nozzle as in claim 6, wherein the set of stimulating means further comprise at least one conductive electrode.

8. A system and nozzle as in claim 7, wherein the conductive electrode is comprised of a metal comprised of any of the set of conductive metals and their alloys.

9. A system as in claim 6 wherein the set of stimulating means further comprise at least two electrodes and at least one is coated with silicate.

10. A system as in claim 6, wherein the set of stimulating means further comprise at least one laser incorporated in the nozzle but directing its emission to any of the interior lining of the nozzle and the fluid.

11. A system as in claim 10, wherein the laser is capable of variable emission.

12. A system as in claim 6, wherein the photonic stimulating means provides a simultaneous, modulated, photonic stimulation.

13. The system as in claim 6, wherein the photonic stimulating means comprises a set of intensity-modulated light emitting diodes.

14. A system as in claim 6, wherein the set of stimulating means comprise:
at least two “ultrabright” white LEDs capable of generating 15,000 mcd spaced equally around the nozzle's throat, each LED in a sealed glass port in the interior lining and directing its light into the fluid F; and,
at least three electrodes, comprising at least a first anode for an RF stimulus, a second anode for a DC stimulus, and a common cathode, with the electrodes forming a triangle with two equilateral sides wherein the shortest side lies between the RD anode and the common cathode; and the electrodes are isolated from the nozzle's structure and concentrate the RF stimulus in the fluid F.

15. A system as in claim 5, wherein the interior lining is a silicate.

16. A system as in claim 5, wherein the fluid F includes a silicate.

17. A system as in claim 16, wherein the fluid F also includes a surfactant.

18. A system as in claim 16, wherein the set of stimulating means further comprise at least one metallic electrode and the silicate included in the fluid F comprises at least one silicate bead threaded over said metallic electrode.

19. A system as in claim 6, wherein the set of stimulating means further comprise:
an anode; and,
provides electrical stimulation to any of the interior lining and fluid by passing a current through the anode.

20. A system as in claim 19 wherein the electrical stimulation varies periodically.

21. A system as in claim 6, wherein the set of stimulating means further comprise:
a cathode; and,
at least one laser incorporated in the nozzle but directing its emission to any of the interior lining of the nozzle and the fluid.

22. A system as in claim 21, wherein both the laser and the anode are capable of variable output.

23. A system as in claim 6, wherein the electrical stimulation is an alternating current voltage having the same frequencies as the absorptive spectra of the solution.

24. A system as in claim 23, wherein the electrical stimulation comprise an RF comb of spectra with spaced peaks in a range of 1 MHz to 200 MHz, at least some of said peaks coinciding with molecular vibrational resonance frequencies in the solution.

25. A system as in claim 6, wherein the electrical stimulation comprises a replication of the electrical energy emitted during the desired exothermic reaction.

26. A system as in claim 7, wherein the electrical stimulation comprises a pattern of an AC current as may be detected from a feedback element incorporated in the nozzle and, by adding a sinusoid with a frequency of 3.1 MHz to another sinusoid having a frequency of 43.4 MHz, forming a ‘doubly layered sinusoid’ resonantly echoed back through the set of stimulating means.
